(19) United States
(12) Patent Application Publication
(10) Pub. No.: US 2017/0277614 A1
(43) Pub. Date: Sep. 28, 2017

(54) INTELLIGENT TEST ROBOT SYSTEM

(71) Applicant: ADLINK TECHNOLOGY INC., New Taipei City (TW)

(72) Inventor: Ming-Che CHENG, New Taipei City (TW)

(21) Appl. No.: 15/081,081

(22) Filed: Mar. 25, 2016

(51) Int. Cl. G06F 11/273; H04L 29/06; G06F 11/263

(52) U.S. Cl. CPC G06F 11/273; G06F 11/263; H04L 69/08; Y10S 901/03

(57) ABSTRACT

The present invention provides intelligent test robot system, which operation platform of intelligent robot body connected storage module for storing test script, operation platform respectively connected signal output unit and image input unit, further connected network communication module linked remote console computer. When operation platform automatically performs tests accordance test script, e.g., power switches, string inputs through keyboard, mouse cursor movements, clicks etc., it is possible to send instructions contained test script to test object via signal output unit for action controls, image input unit receives images outputted by test object and returns them to operation platform, then automatic graphic recognitions can be performed on captured images according to image recognition instructions in test script. Moreover, remote console computer may control plural intelligent robot bodies through Internet for synchronously executing automatic test flows so as to facilitate shortened test time and reduced costs thus further elevating the integral production efficiency.

### BACKGROUND OF THE INVENTION

### 1. Field of the Invention

The present invention provides an intelligent test robot system; in particular, an operation platform thereof can automatically perform tests according to a test script and control the actions of a test object via a signal output unit, and an image input unit receives the images outputted from the test object and returns them to the operation platform, then it is possible to perform automatic test flows on the captured images based on the test script.

### 2. Description of Related Art

Thank to incessant and rapid growth of modern electronic technologies, various electronic devices, e.g., desktop computers, notebook computers, tablet computers, smartphones, vehicle information systems, intelligent television sets or the like, already comprehensively exist in every corners of present societies all over the world, and continue to evolve towards the developments of higher powerful operation capabilities, faster speeds, smaller volumes, finer image/display qualities as well as better power saving features etc. Additionally, because of the standardization in numerous electronic equipment hardware and software, plus everlasting functional expansions and upgrades, vendors and manufacturers have created various electronic equipments suitable for the fields like industrial controls, network and communication apparatuses, mechanical visions and intelligent transportation systems and so on, or for other traffic transportations and aerospace subjects specifically demanding more strict reliability and stability in order to fulfill the requirements on customized specifications and high performance operations in different harsh environments.

Moreover, during automatic operations in electronic device production lines, it is common to utilize different workstations to implement a variety of production flows including machining, assemblages, examinations and tests, warehouse storage and deliveries etc., in which the examinations and tests may be executed by placing in manual test operations along the electronic device manufacture processes thereby removing failed products and improving the production qualities and yields. Considering the temporal factor for rapid electronic devices releases, however, suppose a huge amount of electronic devices are to be installed and examined manually, the required manpower consumptions as well as test times may become significant, which can not fit into the requirements on fast development schedules and production costs of the electronic devices. Consequently, the demands for automatic examinations and production tests are generated and exploited, which allow not only to further enhance the quality controls during the electronic device developments, but also to facilitate the fabrications of products having more desirable qualities at an accelerated tempo.

Furthermore, endless progresses in information industries and improvements on network communication technologies enable a great many industrial automatic equipments of new generations based on real-time communication interfaces with rapid and prosperous developments, thus allowing transfers of digital signals and control parameters through networks as well as creations of motion control techniques featuring higher speeds and better precisions via various communication transmission protocols. To build the test system of high efficiency, some vendors or manufacturers in the industry use local computers in conjunction with the IP-KVM communication technologies to convert images and keyboard/mouse signals into network signals so that a user may remotely control the local computer to proceed tests on a test object. But, since the local computer may not provide sufficient operation capabilities, it is essentially applied just for the purpose of remote controls rather than the automatic tests. Meanwhile, there are also certain people applying a console computer to do tests on a test object by means of the VNC protocols. Although it is possible to achieve the intended test automation through the graphic recognition method, it should be known that, without the installation of an operation system, the console computer is unable to automatically perform the tests, and in case of using a personal computer configured with a general operation system to act as a console computer, it would be difficult to reduce the size and effectively execute centralized control and management. Also, the aforementioned graphic recognition is purely a software-oriented test method, meaning it lacks the ability to perform automatic hardware specification tests or other signal processes on the test object (e.g., power switch on or off etc.), so the integral application functions thereof are still limited. Accordingly, such issues now become the key points to be researched and resolved by those skilled ones in relevant fields.

### SUMMARY OF THE INVENTION

Hence, in view of the above-said issues and drawbacks in prior art, the inventor of the present invention has collected relevant information, worked on various evaluations and considerations of many aspects, along with long-term research and development experiences from numerous practices and modifications in the related realms, thus creating the innovative intelligent test robot system in accordance with the present invention.

The primary objective of the present invention lies in that an operation platform of an intelligent robot body is connected to a storage module for storing a test script, and the operation platform is respectively connected to a signal output unit and an image input unit, and also further connected to a network communication module linked with a remote console computer. When the operation platform automatically performs tests in accordance with the test script, e.g., power switch controls, string inputs through a keyboard, mouse cursor movements, clicks etc., it is possible to send the instructions contained in the test script to a test object via the signal output unit for controlling the actions, and the image input unit receives the images outputted by the test object and returns them to the operation platform, and then the automatic graphic recognitions can be performed on the captured images according to the image recognition instructions in the test script. Moreover, the remote console computer may control plural intelligent robot bodies through the Internet for executing synchronously automatic test flows so as to facilitate shortened test time and reduced costs thus further elevating the integral production efficiency.

The secondary objective of the present invention is that the intelligent robot body may, in addition locally controlling automatic executions of the test processes on the test object, also utilize the IP-KVM communication technology to communicate with the remote console computer via the network communication module by means of the VNC protocol, such that the remote console computer can perform operations and controls over multiple intelligent robot bodies in a one-to-many fashion through the Internet thereby remotely controlling multiple intelligent robot bodies to synchronously perform automatic test flows on the test object, e.g., start test, pause, stop, test script transfer, return test results, test progress etc., thus providing the intelligent robot body enabling various combined features such as automatic graphic recognitions and IP-KVM etc. for achieving the desired software/hardware automatic tests.

Yet another objective of the present invention is to allow the operation platform, storage module, signal output unit, image input unit and network communication module of the intelligent robot body to be integrated into one single system chip, and to minimize and modulize the circuit designs thereby reducing the required volume, such that it is also possible to communicate with the remote console computer by using the single system chip based on the IP-KVM communication technology with the VNC protocol via the Internet thereby enabling the remote console computer to successfully embody the remote operations and controls over the keyboard, image display and mouse of the intelligent robot body through the Internet. Therefore, without the installation of operation system, this type of the intelligent robot body is capable of automatically completing all tests on the test object irrespectively of any operation systems or hardware specifications thereof.

### BRIEF DESCRIPTION OF THE DRAWINGS

FIG. 1 shows a block diagram of the present invention.

FIG. 2 shows a step-wise flowchart of the present invention.

### DETAILED DESCRIPTION OF THE PREFERRED EMBODIMENTS

To achieve the aforementioned objective and effects, with regards to the technical means and structures utilized in the present invention, the structures and functions thereof will be hereunder set forth by the details descriptions concerning the preferred embodiments of the present invention along with appended drawings in order to comprehensively understand the present invention.

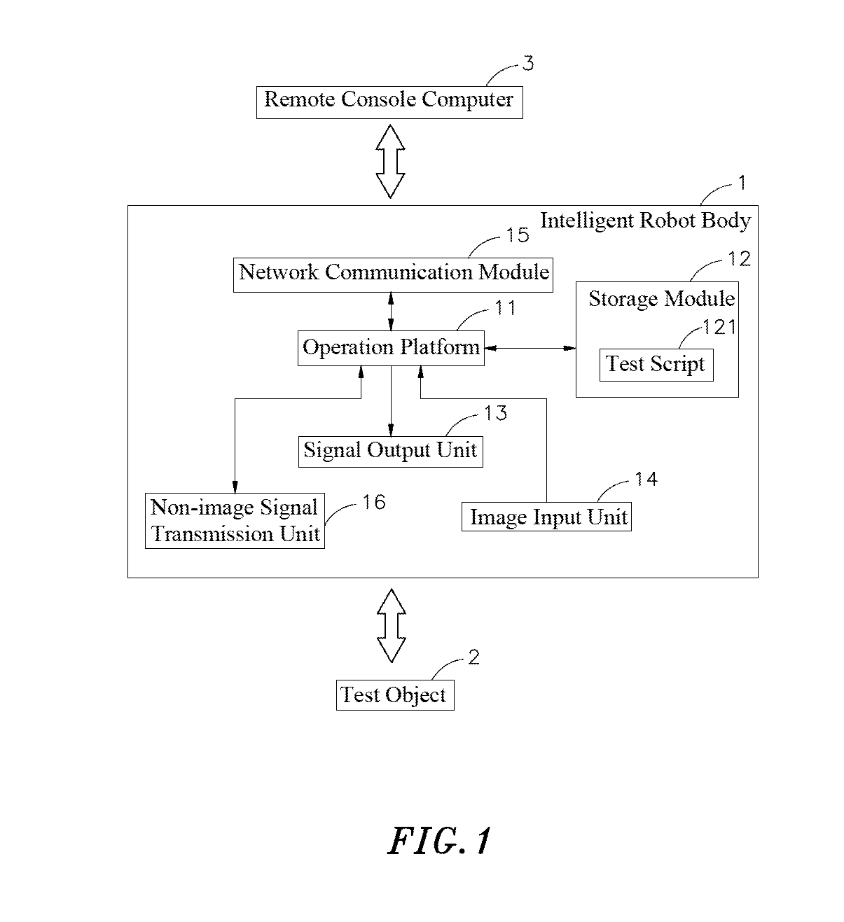

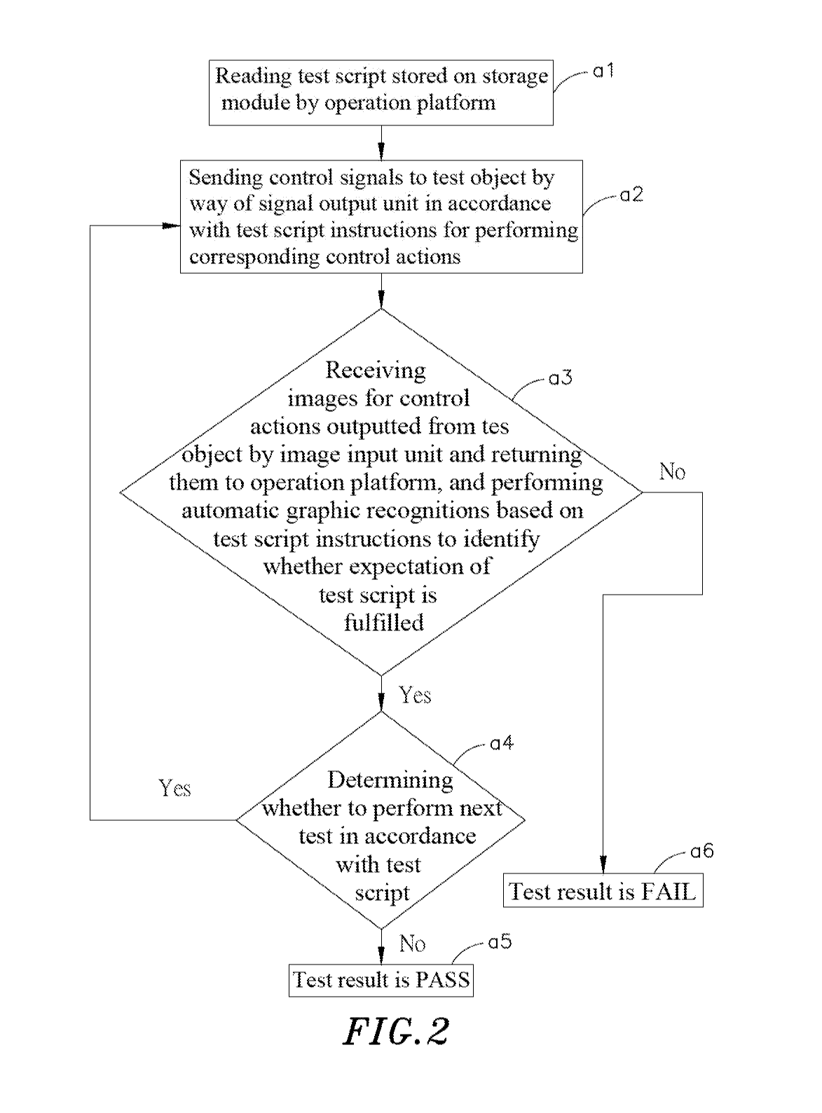

Refer first to FIGS. 1 and 2, wherein a block diagram and a step-wise flowchart of the present invention are respectively shown. It can be clearly observed for the Figures that the intelligent test robot system according to the present invention comprises an intelligent robot body 1, wherein the intelligent robot body 1 includes an operation platform 11, and the operation platform 11 is connected to a storage module 12 for storing a test script 121, and the operation platform 11 is respectively connected to a signal output unit 13 linked to a test object 2 thereby sending the test script 121 instructions to the test object 2 for performing corresponding control actions, as well as to an image input unit 14 capable of receiving the images outputted by the test object 2 in order to return them to the operation platform 11 thereby performing automatic graphic recognitions in accordance with the test script 121 instructions, and further the operation platform 11 is connected to a network communication module 15 linked to a remote console computer 3 for synchronously controlling the operations of the intelligent robot body 1. The operation platform 11 is further connected to a non-image signal transmission unit 16. Moreover, although the test object 2 herein is exemplarily shown as a tablet computer, it may be a smartphone, a notebook computer, an intelligent television set or any other electronic device enabling image output functions as well.

The aforementioned operation platform 11 includes the central processing unit (CPU) and the graphic processing unit (GPU), or otherwise consists of X86-based CPU, Advanced Reduced-instruction-set Machine (ARM) or Field Programmable Gate Array (FPGA) in conjunction with the graphic processing unit (GPU). The storage module 12 may be the random access memory (e.g., DDR3), Flash RAM, hard disk drive (HDD), solid state drive (SSD), electronically erasable programmable read only memory (EEPROM), or any other storage device capable of storing data and the test script 121. Besides, the signal output unit 13 may be a keyboard/mouse having the Universal Serial Bus (USB) interface (USB KB/Mouse), keyboard/mouse having the PS/2 interface (PS/2 KB/Mouse), Universal Asynchronous Receiver/Transmitter (UART), General Purpose Input/Output (GPIO) interface, power switch or any other transmission interfaces allowing to deliver electric power and send control signals or the like to the test object 2 for action controls. In addition, the image input unit 14 can be a Video Graphic Array (VGA), Digital Video Interface (DVI), Display Port (DP), High Definition Multimedia Interface (HDMI) or any other video interfaces capable of receiving the output images from the test object 2, and the network communication module 15 may be the Transmission Control Protocol and Internet Protocol (TCP/IP) of local area network, WiFi, Bluetooth, Wireless sensor network (ZigBee), Ethernet or any other network transmission interfaces enabling Wireless LAN (WLAN) and Wired (LAN) transmission functions. Also, the non-image signal transmission unit 16 may include the Transmission Control Protocol and Internet Protocol (TCP/IP) of local area network, serial port (e.g., RS232, RS485 etc.), General Purpose Input/Output (GPIO) or any other non-image signal transmission interfaces enabling wireless connections (e.g., WLAN) or wired connections (e.g., LAN) with the test object 2, peripheral instruments and equipments (not shown.)

Furthermore, in the intelligent robot body 1 of the present invention, the operation platform 11 (e.g., CPU, ARM or FPGA in conjunction with GPU and so forth), the storage module 12 (e.g., DDR3, Flash RAM, EEPROM etc.), the signal output unit 13, the image input unit 14 as well as the network communication module 15 can be integrated into an integrated circuit of the System-on-a-Chip (SoC) thus allowing minimization and modulization of the entire circuitry designs for reducing the required volume. In practice, however, it is also possible to integrate the non-image signal transmission unit 16 into the integrated circuit of the aforementioned System-on-a-Chip (SoC). In a preferred embodiment of the intelligent robot body 1, it employs an SoC of IP-KVM (KB, Video, Mouse) communication technology built-in onto the motherboard and communicates with the remote console computer 3 by means of the IP-KVM SoC through the Internet with the RFB (Remote Frame Buffer) protocol of the VNC (Virtual Network Computing) such that the remote console computer 3 can implement remote operations and controls over the keyboard, image display and mouse of the intelligent robot body 1 via the Internet. Seeing that the VNC protocol is written in the Java programming language, users can run it on any operation system and connect to the intelligent robot body 1 on the Internet for program executions, and the screen pictures (FB) generated during automatic tests on the test object 2 can be transferred to the remote console computer 3 for synchronous displaying.

Testing on the test object 2 by the intelligent robot body 1 of the present invention comprises the following steps:

(a1) reading the test script 121 stored on the storage module 12 by the operation platform 11;

(a2) sending the control signals to the test object 2 by way of the signal output unit 13 in accordance with the test script 121 instructions for performing corresponding control actions;

(a3) receiving the images for control actions outputted from the test object 2 by the image input unit 14 and returning them to the operation platform 11, and performing automatic graphic recognitions based on the test script 121 instructions to identify whether the expectation of the test script 121 is fulfilled; if yes, performing Step (a4); otherwise, performing Step (a6);

(a4) determining whether to perform the next test in accordance with the test script 121; if yes, repeating to perform Step (a2); otherwise, performing Step (a5);

(a5) the test result is PASS;

(a6) the test result is FAIL.

From the above-said Steps, it can be clearly seen that the intelligent robot body 1 of the present invention can be connected to the remote console computer 3 via the network communication module 15 thereby receiving or downloading the test script 121 and then store the test script 121 to the storage module 12, or otherwise different test script 121 can be received or downloaded based on actual test flows, or directly created (recorded), or else using the test automatic program to automatically generate or program thus completing the test script 121. When the operation platform 11 reads the test script 121 stored in the storage module 12, it is possible to follow the instructions recorded in the test script 121 to automatically execute the test flow, e.g., various control actions such as power switch controls, string inputs with a keyboard, mouse cursor moves, clicks or the like, and then the control signals outputted by the instructions can be sent to the test object 2 via the signal output unit 13 in order to perform corresponding control actions for such power switch, simulated keyboard inputs, mouse cursor moves, clicks on screen, etc. Meanwhile, the image input unit 14 receives the output screen pictures from the test object 2 and returns them to the operation platform 11 for performing the automatic graphic recognitions on the captured images in accordance with the test script 121 instructions.

When the operation platform 11 follows the image recognition instructions in the test script 121 to perform automatic graphic recognitions on the captured images, it is possible to determine whether the expectation of the test script 121 has been fulfilled by using various flow controls, e.g., “If-Else”, or test loop controls and so forth; for example, it may determine whether any specific graphs appear on the screen, the characters appearing on the screen (OCR), continuing to wait until the specific graphs show up on the screen etc., and in practice the test flows for the test object 2 may completely depend on the contents of the test script 121. Then, in case the expectation of the test script 121 is achieved, it determines the test result for the test object 2 is PASS; on the contrary, if the expectation of the test script 121 is not successfully fulfilled, it determines the test result for the test object 2 is FAIL. It should be known that the operation platform 11 of this type of the intelligent robot body 1 can execute the automatic tests on the test object 2 according to the test script 121 without the installation of operation system, and automatically complete all of the tests irrespectively of any operation systems or hardware specifications in the test object 2. In addition to controls over the power switch, keyboard, mouse etc. and image captured on the screen, it is also achievable to arbitrarily expand the input/output ports, or even synchronize peripheral instruments and equipments for data accesses and controls and so forth in order to accelerate the test time and fulfill the requirements on shortened product development schedules and reduced manufacture costs thus improving the integral production efficiency.

Furthermore, the intelligent robot body 1 of the present invention may, in addition locally controlling automatic executions of the test processes on the test object 2, also utilize the IP-KVM communication technology to communicate with the remote console computer 3 via the network communication module 15 by means of the VNC protocol, such that the remote console computer 3 can perform operations and controls over multiple intelligent robot bodies 1 in a one-to-many fashion through the Internet thereby remotely controlling multiple intelligent robot bodies 1 to synchronously perform automatic test flows on the test object 2, e.g., start test, pause, stop, test script 121 transfer, return test results, test progress etc., thus providing the intelligent robot body 1 enabling various combined technologies such as automatic graphic recognitions and IP-KVM or the like for achieving the desired software/hardware automatic tests.

As such, the present invention essentially discloses the intelligent robot body 1 comprising the operation platform 11 which is able to automatically perform tests in accordance with the test script 121 stored in the storage module 12 and send the instructions in the test script 121 to the test object 2 through the signal output unit 13 for action controls, so that the image input unit 14 receives the images outputted from the test object 2 and returns them to the operation platform 11, then the operation platform 11 executes automatic graphic recognitions on the captured images according to the image recognition instructions in the test script 121 thereby determining the test result for the test object 2. Moreover, the remote console computer 3 may be connected to the network communication module 15 via the Internet so as to remotely control plural intelligent robot bodies 1 for synchronously executing automatic test flows on the test object 2 to facilitate shortened test time and reduced costs thus further enhancing the integral production efficiency.

The aforementioned detailed descriptions have been set forth merely with regards to a preferred embodiment of the present invention, but the illustrated embodiment is by no means intended to restrict the scope of the present invention. Accordingly, all other effectively equivalent changes, modifications and alternations made without departing from the scope and spirit of the present invention should be considered as falling within the coverage defined hereunder by the claims of the present invention.

In summary, the intelligent test robot system according to the present invention is capable of, in practice, achieving the aforementioned effects and objectives thus demonstrating the values thereof with regards to usefulness and innovation and fulfilling the requirements on patent applications, so the present application is herein submitted based on relevant regulations in order to legally protect the inventor's efforts for the present invention. Should there be any questions or instructions from the examiners of your Office, the inventor of the present invention will be very pleased to cooperate and provide any further information concerning the present application in details.

What is claimed is:

1. An intelligent test robot system comprising an intelligent robot body, wherein said intelligent robot body includes an operation platform, and said operation platform is connected to a storage module for storing a test script, and said operation platform is respectively connected to a signal output unit linked to a test object thereby sending said test script instructions to said test object for performing corresponding control actions, as well as to an image input unit capable of receiving the images outputted by said test object in order to return them to said operation platform thereby performing automatic graphic recognitions in accordance with said test script instructions, and further said operation platform is connected to a network communication module linked to a remote console computer for synchronously controlling the operations of said intelligent robot body.

2. The intelligent test robot system according to claim 1, wherein said operation platform applies the IP-KVM communication technology and communicates with said remote console computer by the RFB protocol of VNC through the Internet, such that said remote console computer is able to implement remote operations and controls over the keyboard, image displays, mouse on said intelligent robot body.

3. The intelligent test robot system according to claim 1, wherein said operation platform includes the central processing unit (CPU) and the graphic processing unit (GPU), or alternatively CPUs of X86, Advanced Reduced-instruction-set Machine (ARM) or Field Programmable Gate Array (FPGA) in conjunction with the graphic processing unit (GPU).

4. The intelligent test robot system according to claim 1, wherein said storage module includes the random access memory (RAM), flash random access memory (Flash RAM), hard disc drive (HDD), solid state drive (SSD), or electronically erasable programmable read only memory (EEPROM).

5. The intelligent test robot system according to claim 1, wherein said signal output unit includes the keyboard/mouse having the Universal Serial Bus (USB) interface (USB KB/Mouse), keyboard/mouse having the PS/2 interface (PS/2 KB/Mouse), Universal Asynchronous Receiver/Transmitter (UART), General Purpose Input/Output (GPIO) interface or electric power switch.

6. The intelligent test robot system according to claim 1, wherein said image input unit includes the Video Graphic Array (VGA), Digital Video Interface (DVI), Display Port (DP) or High Definition Multimedia Interface (HDMI).

7. The intelligent test robot system according to claim 1, wherein said network communication module enables the Transmission Control Protocol and Internet Protocol (TCP/IP) of local area network, WiFi, Bluetooth, wireless sensor network (ZigBee), or Ethernet transmission interfaces.

8. The intelligent test robot system according to claim 1, wherein said operation platform is further connected to a non-image signal transmission unit linked to said test object, peripheral instruments and devices for data accesses and controls.

9. The intelligent test robot system according to claim 8, wherein said non-image signal transmission unit enables the Transmission Control Protocol and Internet Protocol (TCP/IP) of local area network, serial port or General Purpose Input/Output (GPIO).

10. The intelligent test robot system according to claim 1, wherein the tests performed by said operation platform on the said test object comprises implementations of the following steps:
(a1) reading said test script stored on the said storage module by said operation platform;
(a2) sending the control signals to said test object by way of said signal output unit in accordance with said test script instructions for performing corresponding control actions;
(a3) receiving the images for control actions outputted from said test object by said image input unit and returning them to said operation platform, and performing automatic graphic recognitions based on said test script instructions to identify whether the expectation of said test script is fulfilled; if yes, performing Step (a4); otherwise, performing Step (a6);
(a4) determining whether to perform the next test in accordance with said test script; if yes, repeating to perform Step (a2); otherwise, performing Step (a5);
(a5) the test result is PASS;
(a6) the test result is FAIL.
